(19) United States
(12) Patent Application Publication
(10) Pub. No.: US 2016/0272850 A1
(43) Pub. Date: Sep. 22, 2016

(54) METHOD FOR DRYING ADHESIVE COMPOUNDS

(71) Applicant: TESA SE, Norderstedt (DE)

(72) Inventors: Klaus KEITE-TELGENBÜSCHER, Hamburg (DE); Christian SCHUH, Hamburg (DE)

(73) Assignee: TESA SE, Norderstedt (DE)

(21) Appl. No.: 15/037,443

(22) PCT Filed: Nov. 11, 2014
(86) PCT No.: PCT/EP2014/074251

§ 371 Date: May 18, 2016

(30) Foreign Application Priority Data
Nov. 18, 2013 (DE) 10 2013 223 451.1

(51) Int. Cl. C09J 7/02; B32B 27/30; B32B 27/32; B32B 27/34; B32B 7/12; B32B 27/08

(52) U.S. Cl. CPC C09J 7/0232; B32B 7/12; B32B 27/08; B32B 27/32; B32B 27/34; B32B 27/30; C09J 153/02

(57) ABSTRACT

The aim is to provide an improved method for removing water from an adhesive compound and/or for protecting an adhesive compound against water from the surroundings. This is achieved using a method in which water is removed from a release liner up to a maximum water content of 75 wt. % of the water content in the release liner at a temperature of 23° C. and 50% air humidity, and the release liner is brought into contact with the adhesive compound.

The present invention relates to the technical field of adhesives of the kind used, for example, for adhesive tapes. A new method is proposed for removing water from such adhesives, and is based essentially on the use of an appropriately prepared release liner. The invention further relates to an adhesive tape producible by the method of the invention, and to its use.

Organic/inorganic electronic arrangements and also optoelectronic arrangements are being used more and more frequently in commercial products or are close to market introduction. Such arrangements comprise inorganic or organic electronic structures, examples being organic, organometallic or polymeric semiconductors or else combinations thereof. Depending on the desired application, the products in question are made rigid or flexible, there being an increasing demand for flexible arrangements. Arrangements of these kinds are produced frequently by printing methods such as relief printing, gravure printing, screen printing, planographic printing or else “non-impact” printing such as, for instance, thermal transfer printing, inkjet printing or digital printing. In many instances, however, vacuum methods are also used, such as Chemical Vapour Deposition (CVD), Physical Vapour Deposition (PVD), Plasma-Enhanced Chemical or Physical Deposition (PECVD), sputtering, (plasma) etching or vapour coating. Patterning is accomplished generally through masks.

Examples of (opto)electronic applications that are already available commercially or are of potential market interest include electrophoretic or electrochromic systems or displays, organic or polymeric light-emitting diodes (OLEDs or PLEDs) in presentation and display devices or as lighting, and also electroluminescent lamps, light-emitting electrochemical cells (LEECs), organic solar cells such as dye or polymer solar cells, inorganic solar cells, especially thin-film solar cells, based for example on silicon, germanium, copper, indium and selenium, perovskite solar cells, organic field-effect transistors, organic switching elements, organic optical amplifiers, organic laser diodes, organic or inorganic sensors, or else organic-based or inorganic-based RFID transponders.

Protecting the components in such arrangements from permeates is seen as a technical challenge for the realization of sufficient service life and function of the arrangements within the field of inorganic and organic electronics, particularly organic electronics. Substances considered to constitute permeates here are generally gaseous or liquid substances which invade a solid body and which may penetrate or migrate through said body. Accordingly, many organic or inorganic compounds of low molecular mass may constitute permeates, with water vapour being presently of particular significance.

A large number of electronic arrangements—especially when organic materials are used—are sensitive to water vapour. During the lifetime of the electronic arrangements, therefore, protection by encapsulation is needed, since otherwise the performance drops off over the period of application. Otherwise, for example, under the influence of water vapour, there may be a drastic reduction within a very short time in the luminosity in the case of electroluminescent lamps (EL lamps) or organic light-emitting diodes (OLEDs), in the contrast in the case of electrophoretic displays (EP displays), or in the efficiency in the case of solar cells.

Within the field of inorganic and more particularly organic electronics, therefore, there is a high demand for flexible adhesive bonding solutions which represent a barrier to water vapour. A number of approaches to such adhesive bonding solutions can already be found in the prior art.

Accordingly with relative frequency, liquid adhesives and adhesive bonding agents based on epoxides are used as barrier adhesives, as are described in WO 98/21287 A1, U.S. Pat. No. 4,051,195 A and U.S. Pat. No. 4,552,604 A, for example. Their principal field of use is in edge bonds in rigid arrangements, but also moderately flexible arrangements. Curing takes place thermally or by means of UV radiation.

The use of these liquid adhesives is accompanied, however, by a series of unwanted effects as well. For instance, low molecular mass constituents (VOCs=Volatile Organic Compounds) may damage the sensitive electronic structures of the arrangement and may complicate production. The adhesive, furthermore, has to be applied, in a costly and inconvenient procedure, to each individual constituent of the arrangement. The acquisition of expensive dispensers and fixing devices is necessary in order to ensure precise positioning. The nature of adhesive application, moreover, prevents a rapid, continuous operation. In the laminating step that is subsequently required, the low viscosity may hinder the attainment of a defined film thickness and bond width.

An alternative is to use pressure-sensitive adhesives or hotmelt adhesives to seal (opto)electronic constructions. Among the pressure-sensitive adhesives (PSAs), preference is given to using those which after bonding are crosslinkable by introduction of energy (for example, actinic radiation or heat). Adhesives of these kinds are described in US 2006/0100299 A1 and WO 2007/087281 A1, for example. Their advantage lies in particular in the fact that the barrier effect of the adhesives can be enhanced by crosslinking.

Also known in the prior art is the use of hotmelt (HM) adhesives. Used here in many cases are copolymers of ethylene, as for example ethylene-ethyl acetate (EEA), ethylene-acrylic acid copolymer (EAA), ethylene-butyl acrylate (EBA) or ethylene-methyl acrylate (EMA). Crosslinking ethylene-vinyl acetate (EVA) copolymers are in general used more particularly for solar cell modules based on silicon wafers. Crosslinking takes place during the sealing operation under pressure and at temperatures of above around 120 C. For many (opto)electronic constructions based on organic semiconductors or produced in thin-film processes, this operation is deleterious, because of the high temperatures and the mechanical load imposed by the pressure.

Hotmelt adhesives based on block copolymers or functionalized polymers are described in WO 2008/036707 A2, WO 2003/002684 A1, JP 2005-298703 A and US 2004/0216778 A1, for example. An advantage of these adhesives is that the adhesives themselves do not introduce any substance—or only very little substance—into the construction to be encapsulated that damages the construction itself, whereas this problem is relevant particularly in the case of reactive liquid adhesive systems, more particularly those based on acrylate or on epoxy resin. In view of the high number of reactive groups, these systems have a relatively high polarity, and so, in particular, water is present in them. The amount is generally in the range from less than 100 ppm up to more than 1 wt %. For this reason among others, such liquid adhesives are used primarily as an edge seal to the electronic arrangements, where they are not in direct contact with the active electronic materials.

Another possibility for countering the problem of entrained permeates is to include additionally an absorbing material—called a getter—within the encapsulation, this getter binding—by absorption or adsorption, for example—water or other permeates that permeate through the adhesive or diffuse out of it. An approach of this kind is described in EP1407818 A1, US 2003/0057574 A1 and in US 2004-0169174 A1, among others.

Another measure is to equip the adhesive and/or the substrate and/or the cover of the electronic construction with such binding properties, as is described in WO 2006/036393 A2, DE10 2009 036 970 A1 and DE 10 2009 036 968 A1, for example.

It is possible, furthermore, to use raw materials with a particularly low water content or to free the adhesive from water during production or prior to application, by means, for example, of thermal drying, vacuum drying, freeze drying or the admixing of getters. Disadvantages of such methods are the long drying time and the possibly high or low drying temperatures, which may harm the adhesive or initiate chemical reactions, such as crosslinking for example. Moreover, the operation of admixing and subsequently removing the getters is costly and inconvenient.

Where such adhesive-related measures are taken to reduce the introduction of water into the construction that is to be protected, it is necessary to maintain the properties produced, with the minimum possible restriction, until the adhesive is used. Thus, for example, an adhesive which has been produced in a particularly anhydrous procedure must be protected from water uptake from the environment.

This problem is generally solved by providing the adhesives with packaging which is impervious to permeation or at least which inhibits permeation. Liquid adhesives are generally dispensed into corresponding containers, made of metal, for example. Adhesive tapes are often welded into flexible pouches made from permeation-inhibiting material—for example, from polyethylene film or from a film laminate of aluminum and polyester.

In order to counter weaknesses in the imperviosity of the packaging or to ensure rapid binding of water included, a getter is often included in the packaging as well, in the form for example of a pouch filled with silica gel or zeolite. This getter is generally not in direct contact with the contents. A particular disadvantage with this method is the increased cost and inconvenience of packaging.

A specific problem arises in the packaging of sheetlike adhesives, i.e. adhesive tapes or adhesive sheets: when they are stacked as shapes or wound to form a roll, gas—air, for example—is included, which is not in exchange with the rest of the gas space remaining in the packaging. Unwanted permeates present, for example water vapour, therefore do not reach the getter material located in the packaging, and may therefore migrate into the adhesive. Furthermore, such adhesive tapes generally include a temporary liner material, and also often a carrier material as well. These materials may likewise comprise water, which may easily permeate into the adhesive in view in particular of the large area of contact with said adhesive. Getter pouches or getter pads introduced into the packaging may not reliably scavenge and bind the water.

If the adhesive is applied from a solution or dispersion first to a liner or to a carrier material and then the solvent or dispersion medium, respectively, is dried, the residence time in the usual tunnel drier units is generally not enough to free the adhesive and the liner and/or carrier material from water to a sufficient extent. A production operation with such slowness would also be uneconomic.

EP 2 078 608 A1 discloses the use of liner materials which comprise a special permeation barrier. This approach, however, is not effective against permeates present in the liner or included between liner and adhesive.

There is therefore an ongoing need for liners which reliably protect a sheetlike adhesive from the influence of water.

It is an object of the present invention, therefore, to provide a method which protects adhesive layer not only from water originating from the environment but also from water included in the course of winding or stacking and other processing steps with the adhesive layer preferably in fact being freed from remaining water.

The achievement of this object derives from the fundamental concept of the present invention, namely using a specifically dried liner for the layer of adhesive and hence creating absorption capacity for water within the assembly composed of liner and layer of adhesive. A first general subject of the invention is therefore a method for removing water from an adhesive and/or for protecting an adhesive from ambient water, comprising
a) removing water from a release liner to a water content of at most 75 wt %, preferably at most 50 wt %, more preferably at most 25 wt %, in particular at most 10 wt % of the release liner water content at a temperature of 23° C. and atmospheric humidity of 50%, and
b) contacting the release liner with the adhesive.

The removal of water in this case, which may also be termed the drying of the liner, is accomplished—in line with the above subject of the invention—without addition of drying agent to the liner itself, in other words merely by diffusion of moisture from the interior of the liner to its surface. The moisture is then removed there from the liner. This can be done, for example, by evaporation, or alternatively by absorbing the moisture through a further material, such as a drying agent, which is contacted temporarily with the liner. “Temporary contacting” here means that the further material is removed from the release liner before the liner is removed from the adhesive; in no case, therefore, is the assembly of liner and further material removed in one piece from the adhesive.

The fixing or binding of water in the liner by physical or chemical means is not considered to constitute “removing” in accordance with the invention.

With preference in accordance with the invention, the water content of the release liner after drying is ≦1500 ppm, more preferably ≦1000 ppm, more particularly ≦750 ppm. A lower water content in the liner advantageously enables greater absorption of water from the adhesive and/or the environment.

The method of the invention is more particularly a method for removing water from an adhesive. The expression “removing water from an adhesive” means in the context of the invention that after adhesive and release liner have been contacted, and after water has been removed from the release liner, there is transport of water from the adhesive into the release liner. Of course, and with preference in accordance with the invention, the water content of the release liner at the time of contacting is less than the water content of the adhesive. More preferably the water content of the release liner at the time of contacting is at most 50%, more particularly at most 10%, of the water content of the adhesive.

In one embodiment of the method of the invention, step a) takes place before step b). With this variant of the method, the penetration of water vapour from the environment into the adhesive to be protected can advantageously be prevented, and water vapour present in the adhesive and included between liner and adhesive can advantageously be bound. The adhesive itself, or a product comprising the adhesive, does not, therefore, need to be freed separately from water.

On contacting, the adhesive may take the form of a film of adhesive or else may be coated from a fluid phase onto the dried release liner. In that case it is preferred if the fluid phase contains no water as solvent or dispersion medium, since otherwise the absorption capacity of the liner would be too rapidly exhaustive.

This method variant has the advantage that the liner can first of all be freed from water at economically acceptable cost and inconvenience, by long-term storage at elevated temperature and/or in a dry environment, such as under reduced pressure or in an atmosphere with a low water vapour content, such as a glove box, for example, and only then is the liner processed in adhesive tape manufacturing steps that give rise to cost and inconvenience, such as coating or lamination, for example.

In another embodiment of the method of the invention, step b) takes place before step a). The advantage of this is that, in a rapid drying operation, first of all only the liner is freed from water and, during subsequent storage, the dried liner is able to free the adhesive from water or else it retards the ingress of water to the adhesive.

This is advantageous in particular if the adhesive possesses a low water vapour permeation rate (Water Vapour Transmission Rate—WVTR), and so can be dried only very slowly. The WVTR of the release liner in this variant of the method is preferably more than 500 g/m²d. In this case, the liner can be dried particularly quickly on a comparative basis.

In this variant of the method it is further preferred if the energy needed for removing the water is introduced substantially from the side of the release liner, as may be realized by convection, conduction or radiation of heat, for instance. Temperatures which can be tolerated on the liner surface in this case lie above the temperature which is tolerable for the adhesive, for instance because the adhesive otherwise is decomposed, undergoes separation, or is adversely affected by a chemical reaction. The surface temperature of the liner may advantageously be at least 20° C., frequently in fact more than 50° C., above the surface temperature of the adhesive.

Particularly preferred is a variant of the method wherein steps a) and b) take place on both sides of the adhesive.

Adhesive tapes coated with adhesives on one or both sides are usually wound up at the end of the production procedure into a roll in the form of an archimedean spiral. In order to prevent the adhesives in double-sided adhesive tapes from coming into contact with one another, or in order to prevent the adhesive sticking to the carrier in the case of single-sided adhesive tapes, the adhesive tapes are lined before winding with a liner material (also called release material) which is wound up together with the adhesive tape. The skilled person knows of such liner materials as simply liners or—used synonymously both generally and in the context of the present text—release liners. In addition to the lining of single-sided or double-sided adhesive tapes, liners are also used for lining pure adhesives (adhesive transfer tapes) and adhesive-tape sections (labels, for example).

A liner, accordingly, is a covering material which has an antiadhesive (abhesive) surface and is applied, for the temporary protection of an adhesive, directly to the adhesive, and can generally be removed by simple peeling immediately prior to application of the adhesive.

These release liners also ensure that the adhesive is not contaminated prior to use. In addition, release liners can be tailored via the nature and composition of the release materials to allow the adhesive tape to be unwound with the desired force (easy or difficult). In the case of adhesive tapes coated with adhesive on both sides, moreover, the release liners ensure that the correct side of the adhesive is exposed first during unwinding.

A liner is not part of an adhesive tape, but merely an aid to its production, storage or further processing. Furthermore, in contrast to an adhesive tape carrier, a liner is not firmly joined to a layer of adhesive; instead, the assembly is only temporary and not permanent.

A liner comprises at least one abhesive release layer. The term “abhesive” expresses in accordance with the invention the idea that the release layer has a lower adhesion to the adhesive that is to be covered than does the adhesive to the intended application substrate in its use, and, where appropriate, to the carrier material belonging to the adhesive.

The material of the abhesive release layer is preferably selected from the group encompassing silicones, fluorinated silicones, silicone copolymers, waxes, carbamates, fluoropolymers and polyolefins or mixtures of two or more of the stated substances. With particular preference the material of the abhesive release layer is selected from silicones and polyolefins.

The system forming the abhesive release layer is preferably formulated in such a way that there is essentially no diffusion of abhesive substances into the adhesive. Analytically it may still be possible to detect substances from the abhesive coating, but these can be attributed to mechanical abrasion.

The abhesive release layer preferably has essentially no vapour pressure at room temperature.

The abhesive release layer preferably consists of a silicone system. Such silicone systems are preferably produced using crosslinkable silicones. These include mixtures of crosslinking catalysts and so-called thermally curable, condensation-crosslinking or addition-crosslinking polysiloxanes. As crosslinking catalysts for condensation-crosslinking silicone systems, there are frequently tin compounds present in the composition, such as dibutyltin diacetate.

Silicone-based release agents on an addition-crosslinking basis can be cured by hydrosilylation. These release agents typically comprise the following constituents:
an alkenylated polydiorganosiloxane (more particularly, linear polymers having terminal alkenyl groups),
a polyorganohydrogensiloxane crosslinking agent, and
a hydrosilylation catalyst.

Established catalysts for addition-crosslinking silicone systems (hydrosilylation catalysts) include, for example, platinum or compounds of platinum, such as the Karstedt catalyst (a Pt(0) complex compound), for example.

Thermally curing release coatings are therefore frequently multi-component systems, consisting typically of the following components:
a) a linear or branched dimethylpolysiloxane which consists of around 80 to 200 dimethylpolysiloxane units and is stopped with vinyldimethylsiloxy units at the chain ends. Typical representatives are, for example, solvent-free, addition-crosslinking silicone oils having terminal vinyl groups, such as Dehesive® 921 or 610, both available commercially from Wacker-Chemie GmbH;
b) a linear or branched crosslinker, typically composed of methylhydrogensiloxy units and dimethylsiloxy units, with the chain ends being satisfied either with trimethylsiloxy groups or dimethylhydrogensiloxy groups. Typical representatives of this class of product are, for example, hydrogenpolysiloxanes having a high reactive Si—H content, such as the crosslinkers V24, V90 or V06, which are available commercially from Wacker-Chemie GmbH;
c) a silicone MQ resin, possessing as M unit not only the trimethylsiloxy units typically used but also vinyldimethylsiloxy units. Typical representatives of this group are, for example, the release force regulators CRA® 17 or CRA® 42, available commercially from Wacker-Chemie GmbH;
d) a silicone-soluble platinum catalyst such as, for example, a platinum-divinyltetramethyldisiloxane complex, which is commonly dubbed Karstedt complex and is available commercially for example under the name Katalysator OL from Wacker-Chemie GmbH.

It is also possible to use photoactive catalysts, known as photoinitiators, in combination with UV-curable, cationically crosslinking siloxanes based on epoxide and/or vinyl ether, and/or UV-curable, free-radically crosslinking siloxanes such as, for instance, acrylate-modified siloxanes. The use of electron beam-curable silicone acrylates is likewise possible. Such systems, depending on their intended use, may also include further additions such as stabilizers or flow control assistants.

Silicone-containing systems may be acquired commercially from Dow Corning, Wacker or Rohm&Haas, for example.

Examples are Dehesive® 914, which comprises a vinylpolydimethylsiloxane, Crosslinker V24, a methylhydrogenpolysiloxane, and Catalyst Ol, a platinum catalyst in polydimethylsiloxane. This system is available from Wacker-Chemie GmbH.

Also possible for use, for example, is the commercially available addition-crosslinking silicone release system Dehesive® 940A from Wacker-Chemie with an associated catalyst system, which is applied in the non-crosslinked state and then subsequently crosslinked in the applied state.

Particular embodiments of the silicone systems are polysiloxane block copolymers, with a urea block, for example, like those available from Wacker under the trade name “Geniomer”, or release systems comprising fluorosilicones, which are used in particular with adhesive tapes featuring silicone adhesives.

Polyolefinic release layers may consist of thermoplastic, non-elastic or elastic materials. For example, such release layers may be based on polyethylene. For this purpose it is possible to utilize polyethylenes in the entire realizable density range from approximately 0.86 g/cm³ to 1 g/cm³. For certain applications, polyethylenes of lower density are appropriate with preference, since they frequently produce lower release forces.

Release layers having elastic properties may also consist of olefin-containing elastomers. Examples include both random copolymers and block copolymers. Examples among the block copolymers include ethylene-propylene rubbers, butyl rubber, polyisobutylene, ethylene block copolymers, and also partly and fully hydrogenated styrene-diene block copolymers such as, for example, styrene-ethylene/butylene and styrene-ethylene/propylene block copolymers.

Suitable release layers can also be provided, furthermore, by acrylate copolymers. Preferred embodiments of this variant are acrylate polymers having a static glass transition temperature (mid-point Tg as determined via differential calorimetry) which is below room temperature. The polymers are typically crosslinked. Crosslinking may be chemical or physical, of the kind realized in block copolymers, for example.

The abhesive release layer may be applied directly by means of a coating bar from solution, emulsion or dispersion. The solvent, emulsifying medium or dispersing medium used, respectively, may in this case be evaporated subsequently in a commercial dryer. Solvent-free coating by means of a nozzle or roll coating unit is also suitable.

The abhesive layer may also be printed. Suitable for this purpose in accordance with the prior art are gravure and screen printing processes. It is preferred here to employ rotary printing processes. Furthermore, abhesive coatings may also be applied by spraying. This may take place in a rotary spraying process, optionally also electrostatically.

The material of the abhesive release layer and the material of any carrier layer optionally present need not take the form of homogeneous materials, but instead may also consist of mixtures of two or more materials. Accordingly, for the purpose of optimizing the properties and/or processing, the materials may in each case have been blended with one or more additives such as resins, waxes, plasticizers, fillers, pigments, UV absorbers, light stabilizers, ageing inhibitors, crosslinking agents, crosslinking promoters, defoamers, degassing agents, wetting agents, dispersing assistants, rheology additives or elastomers.

In the simplest case, the release liner of the method of the invention consists only of the abhesive release layer. In a further embodiment, the liner includes at least one carrier layer. In this case the abhesive release layer may be applied directly to the carrier layer and may at least partially cover said layer. Typically, an abhesive release layer is applied in the form of a continuous (uninterrupted) outermost layer at least on the adhesive-facing side of the carrier material.

Independently of the presence of a carrier layer, the liner may also have an abhesive surface on both sides, at least partially, and this surface may be the same or different.

As carrier material of a liner it is possible to use papers, plastic-coated papers or films/foils, with preference being given to films/foils, more particularly to dimensionally stable polymeric films or metallic foils. The carrier layer therefore consists frequently of polyesters, more particularly of polyethylene terephthalate, for example of biaxially oriented polyethylene terephthalate, or of polyolefins, more particularly of polybutene, cycloolefin copolymer, polymethylpentene, polypropylene or polyethylene, for example of monoaxially oriented polypropylene, biaxially oriented polypropylene or biaxially oriented polyethylene. These materials generally have only a low water absorption capacity of less than 0.5 wt %.

In the method of the invention, the release liner preferably comprises at least one polymeric film having a water absorption capacity of more than 0.5 wt %, more particularly of more than 2 wt %. With particular preference the material of the polymeric film is selected from the group consisting of polyamide, polyamide copolymers, polyvinyl butyral, polyvinyl alcohol, polyvinyl acetate, cellulose acetate, cellulose acetate derivatives, cellulose hydrate (cellophane), cellulose propionate, cellulose acetobutyrate, polysulphone and polysulphone derivatives.

Papers or nonwovens are also suitable in principle as carrier material of the liner for the purposes of the invention. Papers in this context are notable for particularly high water absorption and, by virtue of their porous structure, for ready dryability.

The release liner in the method of the invention preferably comprises a layer, more particularly a carrier layer, having a water vapour permeation rate of at least 1000 g/m²d for a thickness of 50 μm.

The thickness of release liners is generally from 10 to 250 μm. Preferred for the method of the invention is a liner having a thickness of more than 50 μm, since in that case there is a greater capacity available for water absorption. Particularly preferred is a liner having a thickness of more than 250 μm, since with this liner an even greater water absorption capacity can be provided.

The liner in the method of the invention preferably comprises a barrier layer against water vapour. More preferably the release liner comprises at least one layer having a water absorption capacity of more than 0.5 wt %, preferably of more than 2 wt %, and at least one layer having a barrier function towards water vapour, more particularly a layer having a WVTR of ≦0.1 g/m²d, where the layer having a water absorption capacity of more than 0.5 wt %, after having been contacted with the adhesive, is disposed nearer to the adhesive than is the layer having the barrier function. A liner of this kind is preferably dried, accordingly, prior to being contacted with the layer of adhesive. A barrier function of this kind may consist of organic or inorganic materials. Liners with a barrier function are set out comprehensively in EP 2 078 608 A1.

With preference the liner comprises at least one inorganic barrier layer. Suitable inorganic barrier layers include metals or, in particular, metal compounds such as metal oxides, metal nitrides or metal hydronitrides that are deposited particularly well under reduced pressure (for example by means of evaporation, CVD, PVD, PECVD) or under atmospheric pressure (for example by means of atmospheric plasma, reactive corona discharge or flame pyrolysis), examples being oxides or nitrides of silicon, of boron, of aluminum, of zirconium, of hafnium or of tellurium and also indium tin oxide (ITO). Likewise suitable are layers of the aforementioned variants that are doped with further elements. Metal foils are also suitable barrier layers.

With preference the liner comprises at least one carrier layer and at least one barrier layer, the barrier layer and the carrier layer taking the form of layers which follow one another directly. A particularly suitable method for applying an inorganic barrier layer in this context is high-power impulse magnetron sputtering or atomic layer deposition, by means of which it is possible to realize layers which are particularly impervious to permeation, while imposing a low temperature load on the carrier layer. Preference is given to a permeation barrier, of the carrier layer with barrier function or of the assembly of carrier layer and barrier layer, against water vapour (WVTR) of <1 g/m²d, the value being based on the respective carrier layer and barrier layer assembly thickness used in the liner, in other words not standardized to a specific thickness. The WVTR is measured at 38° C. and 90% relative atmospheric humidity in accordance with ASTM F-1249, in accordance with the invention.

The material of the abhesive release layer preferably has a water vapour permeability of at least 100 g/m²d, more preferably of at least 500 g/m²d, based in each case on a layer thickness of 50 μm. The material of the abhesive release layer here means the pure release layer material without any possible addition. The stated water vapour permeability for the release layer material is advantageous in that the water vapour passes particularly rapidly and effectively to the dried carrier material, especially from the side of the adhesive. Particularly preferred, therefore, is the use of a silicone-based or acrylate-based release layer.

The release liner in the method of the invention preferably consists of a carrier layer and of an abhesive release layer, in other words containing exclusively these two layers. This is advantageous because a liner of this kind is more flexible than a multi-layer liner, and the anchorage between the two layers is easier to achieve than with a multi-layer liner. Furthermore, a liner of this kind can be produced with a lower level of material. Relative to a liner consisting only of the release layer, this embodiment has the advantage that the release function and the mechanical stabilizing function are present decoupled in two layers, and therefore particularly suitable materials can be selected in each case.

In another preferred variant of the method, the liner consists of a carrier layer, an abhesive release layer, and a primer layer disposed between carrier layer and release layer.

The liner in the method of the invention is preferably transparent, meaning that the transmittance as measured according to ASTM D1003-00 (Procedure A) is greater than 50%, preferably greater than 75%. With a transparent liner, the adhesive can be more easily positioned in the application.

Likewise preferably, the liner in the method of the invention is impervious to UV light, meaning that the transmittance in a wavelength range from 200 to 400 nm as measured according to ASTM D1003-00 (Procedure B) is less than 25%, preferably less than 10%. With a UV-impervious liner, the adhesive can be protected from changes (for example chemical reactions, ageing, crosslinking) caused by UV light.

A further subject of the present invention is an adhesive tape which is covered at least on one side and at least partially with a release liner, and is producible by a method of the invention. The adhesive of the adhesive tape of the invention is preferably a pressure-sensitive adhesive or an activatable adhesive and more particularly an activatable pressure-sensitive adhesive.

Pressure-sensitive adhesives (PSAs) are adhesives whose set film in the dry state at room temperature remains permanently tacky and adhesive. Even with relatively weak applied pressure, PSAs permit a durable bond to be made to the substrate.

In accordance with the invention it is possible to use all PSAs known to the skilled person, thus including, for example, those based on acrylates and/or methacrylates, polyurethanes, natural rubbers, synthetic rubbers; styrene block copolymer compositions with an elastomer block composed of unsaturated or hydrogenated polydiene blocks such as, for example, polybutadiene, polyisoprene, and copolymers of both and also further elastomer blocks familiar to the skilled person; polyolefins, fluoropolymers and/or silicones.

Where acrylate-based PSAs are referred to in the context of this specification, the term encompasses, without explicit reference, PSAs based on methacrylates and those based on acrylates and methacrylates, unless expressly described otherwise. Likewise suitable for use in the sense of the invention are combinations and mixtures of two or more base polymers and also adhesives additized with tackifier resins, fillers, ageing inhibitors and crosslinkers, the recitation of the additives being only by way of example and being non-limiting in its interpretation.

Preference is given to PSAs based on styrene block copolymers, polybutylenes, polyolefins or fluoropolymers, since these adhesives are notable for a high permeation barrier against water vapour and also for a low water content.

Activatable adhesives are considered to be those adhesive systems where bonding is accomplished as a result of an input of energy, by actinic radiation or heat, for example.

Heat-activatedly bonding adhesives can be classed in principle in two categories: thermoplastic heat-activatedly bonding adhesives (hotmelt adhesives) and reactive heat-activatedly bonding adhesives (reactive adhesives). Likewise encompassed are those adhesives which can be assigned to both categories, namely reactive thermoplastic heat-activatedly bonding adhesives (reactive hotmelt adhesives).

Thermoplastic adhesives are based on polymers which on heating undergo reversible softening and solidify again during cooling. Thermoplastic adhesives which have emerged as being advantageous are especially those based on polyolefins and copolymers of polyolefins and also on their acid-modified derivatives, on ionomers, on thermoplastic polyurethanes, on polyamides and also polyesters and copolymers thereof, and also on block copolymers such as styrene block copolymers.

In contrast, reactive heat-activatedly bonding adhesives comprise reactive components. The latter constituents are also identified as “reactive resins”, in which heating initiates a crosslinking process which after the end of the crosslinking reaction ensures a durable, stable bond. Such adhesives preferably also comprise elastic components, for example synthetic nitrile rubbers or styrene block copolymers. Such elastic components give the heat-activatedly bonding adhesive particularly high dimensional stability even under pressure, on account of their high flow viscosity.

Radiation-activated adhesives are likewise based on reactive components. The latter constituents may comprise, for example, polymers or reactive resins in which the irradiation initiates a crosslinking process which after the end of the crosslinking reaction ensures a durable, stable bond. Such adhesives preferably also comprise elastic components, such as those recited above.

It is preferred to use activatable adhesives based on epoxides, oxetanes, (meth)acrylates or modified styrene block copolymers.

The adhesive before being contacted with the liner preferably has a water content of less than 2000 ppm, more preferably of less than 500 ppm. The ppm figure here refers to the relation between the total weight of water present and the analysed weight of adhesive. The water content may be determined in the case of the invention in accordance with DIN 53715 (Karl-Fischer titration) after storage of the test specimen for 24 hours at 23° C. and 50% relative atmospheric humidity. In the case of the water contents of the adhesive that are described here, the capacity of the dried liner is not so greatly taxed by water diffusing out of the adhesive, but the liner is able better to fulfill its function as a cover which protects against water from the environment.

The adhesive preferably has a water vapour permeation rate (WVTR) of at most 50 g/m²d, more preferably at most 20 g/m²d, based on an adhesive thickness of 50 μm. As a result of the low water vapour permeation rate on the part of the adhesive, less water diffuses from the environment through the adhesive and into the dried liner, which is able therefore to fulfill its function for longer. This facilitates the production and converting of the adhesive tape, for example.

The adhesive tape of the invention thus comprises at least one layer of a PSA or of an activatable adhesive or more particularly of an activatable PSA. The adhesive tape may also comprise further layers, for example one or more further layers of adhesive, or a carrier material.

The adhesive tape preferably comprises only one layer of an adhesive (adhesive transfer tape), since this keeps the construction simple and allows the water vapour permeation rate of the adhesive tape to be optimized more easily, as a result of the relatively low diversity of materials. Furthermore, there is no carrier material to hinder the diffusion of water vapour from the adhesive tape to the dried liner, allowing the adhesive tape to be freed from water in a particularly efficient way.

The thickness of the adhesive tape may span all customary thicknesses, in other words, approximately, from 3 μm up to 3000 μm. A thickness of between 25 and 100 μm is preferred, since, within this range, bond strength and handling properties are particularly positive. A further preferred range is a thickness of 3 to 25 μm, since in this range the amount of water permeating through the bondline can be minimized solely by the small cross-sectional area of the bondline in an encapsulation application. It has emerged, moreover, that such low adhesive tape thicknesses can be freed effectively from permeates through the dried liner.

To produce an assembly composed for example of an adhesive tape and the dried liner, the liner may be coated or printed on one side with the adhesive of the adhesive tape, from solution or dispersion or in 100% form (as a melt, for example), or the assembly is produced by coextrusion. An alternative option is to form the assembly by transfer of a layer of adhesive or of a dried liner by lamination. The adhesive tape carrier may of course also be involved in the above operations. The layer or layers of adhesive may be crosslinked by heat or high-energy radiation. The above operations preferably take place in an environment in which water is present only in a low concentration or almost not at all. An example that may be given is a relative atmospheric humidity of less than 30%, preferably of less than 15%.

To optimize the properties it is possible for the adhesive composition employed to be blended with one or more additives such as tackifiers (resins), plasticizers, fillers, pigments, UV absorbers, light stabilizers, ageing inhibitors, crosslinking agents, crosslinking promoters or elastomers.

The amount of the layer of adhesive is preferably 10 to 200 g/m², preferably 25 to 120 g/m², where “amount” means the amount after any removal of water or solvent that may be carried out.

The present invention further relates to the use of an adhesive tape produced by the method of the invention and covered at least on one side and at least partially with the release liner for encapsulating an optoelectronic arrangement and/or an organic electronic arrangement.

The invention further relates to a release liner which comprises at least one carrier material and at least one release layer and is characterized in that the release liner is in the form of a roll and the side faces of two adjacent plies of the release liner are not in direct contact with each other. This makes the liner easier to dry. Accordingly, for example, individual spacers may be incorporated into the archimedean spiral of the roll during winding.

Wound preferably between the adjacent plies of the release liner is a membrane having a water vapour permeation rate of at least 1000 g/m²d for a thickness of 50 μm. This advantageously enables efficient transport of water vapour from the roll interior. Membranes used are preferably sheet textiles such as nonwoven, woven, laid or knitted fabrics or the like. Also especially apt, though, are open-pored foams and papers.

The membrane may also be part of the liner itself, as, say, a carrier material. The carrier material is then preferably both a water-absorbing and a ‘breathable’ medium.

### EXAMPLES

Various release liners were dried and laminated with layers of adhesive in a controlled-climate chamber at 23° C. and a relative atmospheric humidity of 50%.

Layers of Adhesive:

To produce layers of adhesive, different adhesives were applied, using a laboratory coating instrument, from a solution to a conventional liner which is impervious to permeation, this liner being of the type ALU I 38 UV1 from Mondi, comprising an aluminum foil carrier, and the coatings were dried. The liner absorbs no water to any notable extent. The layer thickness of the adhesive after drying was 25 μm in each case. Drying took place in each case at 120° C. for 30 minutes in a laboratory drying cabinet.

K1: Pressure-Sensitive Adhesive

| 100 parts | Tuftec | SBBS with 30 wt % block polystyrene content from |
|---|---|---|
| | P 1500 | Asahi. The SBBS contains about 68 wt % diblock |
| | | content. |
| 100 parts | Escorez | hydrogenated HC resin with a softening point of |
| | 5600 | 100° C., from Exxon |
| 25 parts | Ondina | white oil comprising paraffinic and naphthenic |
| | 917 | fractions, from Shell |

The solvent used was a 2:1 mixture of toluene and acetone.

K2: Radiation-Activatable Hotmelt Adhesive

| | | |
|---|---|---|
| 25 parts | Epiclon | bisphenol A and bisphenol F based epoxy resin from |
| | 835 LV | DIC, Japan, molecular weight M_{w} about 350 g/mol |
| 25 parts | Epicote | bisphenol based epoxy resin from |
| | 1001 | Mitsubishi Chemical Company, Japan, molecular |
| | | weight M_{w} about 900 g/mol |
| 50 parts | YP-70 | bisphenol A and bisphenol F based phenoxy resin |
| | | from Nippon Steel Chemical Group, Japan, |
| | | molecular weight M_{w} about 55 000 g/mol |
| 1.5 parts | Irgacure | iodonium salt-based UV photoinitiator from BASF |
| | 250 | (iodonium, (4-methylphenyl) [4-(2-methylpropyl) |
| | | phenyl]-, hexafluorophosphate(1-)) |

The solvent used was methyl ethyl ketone.

K3: Radiation-Activatable Pressure-Sensitive Adhesive

| | | |
|---|---|---|
| 50 parts | Uvacure | reactive resin from Cytec |
| | 1500 | |
| 20 parts | Regalite | fully hydrogenated HC resin (hydrocarbon resin) |
| | R1100 | having a softening point of 100° C., from Eastman |
| 30 parts | Sibstar | polystyrene-block-polyisobutylene block copolymer |
| | 73T | from Kaneka, with a styrene fraction in the total |
| | | polymer of 30 wt % and with a molar mass M_{w} of |
| | | 70 000 g/mol |
| 1.5 parts | Irgacure | iodonium salt-based UV photoinitiator from BASF |
| | 250 | (iodonium, (4-methylphenyl) [4-(2-methylpropyl) |
| | | phenyl]-, hexafluorophosphate(1-)) |

These raw materials were dissolved in a mixture of toluene (30 wt %), acetone (15 wt %) and special-boiling-point spirit 60/95 (55 wt %), to give a 50 wt % solution.

The adhesives were stored over 72 hours at 23° C. and 50% relative atmospheric humidity. The water content of the adhesives was determined in each case prior to lamination to the liner.

Liner

The carrier films used for the liner were as follows:
cast polyamide 6 film from MF-Folien, Kempten, with a thickness of 100 μm (liner 1)
Tacphan P91 cast cellulose triacetate film from LoFo, Weil am Rhein, having a thickness of 80 μm (liner 2)

Release systems were coated onto the films, with the release system formulation indicated below being applied using a laboratory coating unit. The coating weight was 2 g/m². After coating, the release systems were crosslinked in a forced air oven at 160° C. for 30 seconds.

The silicone system used is an addition-crosslinking silicone system from Wacker. 9.75 g of DEH 915 (a polydimethylsiloxane functionalized with vinyl groups) were mixed with 0.33 g of V24 (a methylhydrogenpolysiloxane) and 0.08 g of Kat OL (a platinum catalyst, also known under the name Karstedt catalyst).

Further liners used were commercial liners based on a 75 μm PET film (Silphan S75 M371 from Siliconature, Italy, liner 3) and based on a paper (KS 900 white 52B 20 from Laufenberg, Krefeld, liner 4).

The liners were conditioned or dried for various lengths of time under various conditions:
Conditions A: 3 days at 80° C. with a relative humidity of 20%
Conditions B: 3 days at room temperature in a glove box at a water vapour level of less than 10 ppm
Conditions C: 3 days at 23° C. with a relative humidity of 50%
Conditions D: 5 minutes at 120° C. in a forced air oven

After having been dried, the liners were welded into vacuumed pouches made from a film laminate impervious to permeation (polyester film/aluminum foil/sealing adhesive film) and were not taken out until immediately prior to use.

Measurement of the Water Content

The water content was determined in accordance with DIN 53715 (Karl-Fischer titration). Measurement took place on a Karl-Fischer Coulometer 851 in conjunction with an oven sampler (oven temperature 140° C.). A triple determination was carried out in each case with an initial mass of around 0.3 g. The water content reported is the arithmetic mean of the measurements.

For further investigation, adhesive-tape sections measuring about 100×100 mm² were conditioned as already described above and immediately thereafter were lined, at 23° C. and 50% relative humidity, with a liner which had been likewise conditioned and/or dried, using a laboratory laminator. The laminates produced in this way were stored for 72 hours, sealed within vacuumed packaging impervious to permeation.

Finally, the water content of the adhesive in the specimens was measured. For this, samples were taken from the centre of the specimen area, in order to avoid edge effects. The results are summarized in Table 1:

TABLE 1
Determination of water content

| | | | | | | Adhesive |
|---|---|---|---|---|---|---|
| | | | | Liner | Adhesive | water |
| | | | | water | water content | content |
| | | | | content | [ppm (mass | [ppm] |
| | | | Liner | [ppm] | fraction)] | After |
| | Liner | Adhesive | conditioning | After conditioning/drying | | storage |
| Example | | | | | | |
| 1 | L1 | K1 | Conditions A | 630 | 853 | 222 |
| 2 | L2 | K1 | Conditions A | 860 | 853 | 200 |
| 3 | L3 | K1 | Conditions A | 1700 | 853 | 513 |
| 4 | L4 | K1 | Conditions A | 5300 | 853 | 444 |
| 5 | L1 | K1 | Conditions B | 190 | 853 | 67 |
| 6 | L2 | K1 | Conditions B | 180 | 853 | 42 |
| 7 | L3 | K1 | Conditions B | 210 | 853 | 288 |
| 8 | L4 | K1 | Conditions B | 450 | 853 | 38 |
| 9 | L1 | K2 | Conditions A | 630 | 3216 | 838 |
| 10 | L2 | K2 | Conditions A | 860 | 3216 | 754 |
| 11 | L3 | K2 | Conditions A | 1700 | 3216 | 1933 |
| 12 | L4 | K2 | Conditions A | 5300 | 3216 | 1673 |
| 13 | L1 | K2 | Conditions B | 190 | 3216 | 253 |
| 14 | L2 | K2 | Conditions B | 180 | 3216 | 158 |
| 15 | L3 | K2 | Conditions B | 210 | 3216 | 1085 |
| 16 | L4 | K2 | Conditions B | 450 | 3216 | 142 |
| 17 | L1 | K3 | Conditions A | 630 | 1009 | 263 |
| 18 | L2 | K3 | Conditions A | 860 | 1009 | 237 |
| 19 | L3 | K3 | Conditions A | 1700 | 1009 | 606 |
| 20 | L4 | K3 | Conditions A | 5300 | 1009 | 525 |
| 21 | L1 | K3 | Conditions B | 190 | 1009 | 79 |
| 22 | L2 | K3 | Conditions B | 180 | 1009 | 50 |
| 23 | L3 | K3 | Conditions B | 210 | 1009 | 341 |
| 24 | L4 | K3 | Conditions B | 450 | 1009 | 45 |
| Comparative | | | | | | |
| examples | | | | | | |
| C1 | L1 | K1 | Conditions C | 14 500 | 853 | 818 |
| C2 | L2 | K1 | Conditions C | 17 600 | 853 | 823 |
| C3 | L3 | K1 | Conditions C | 2800 | 853 | 803 |
| C4 | L4 | K1 | Conditions C | 55 000 | 853 | 825 |
| C5 | L1 | K2 | Conditions C | 14 500 | 3216 | 2980 |
| C6 | L2 | K2 | Conditions C | 17 600 | 3216 | 3130 |
| C7 | L3 | K2 | Conditions C | 2800 | 3216 | 3110 |
| C8 | L4 | K2 | Conditions C | 55 000 | 3216 | 2890 |

The results show that the method of the invention is suitable for removing water from an adhesive. In the comparative examples there is no notable drying, and/or the level of drying achieved is not sufficient to allow, for example, application for the encapsulation of sensitive organic electronic constructions.

In a further experiment, the adhesive K3 was coated directly from solution onto the liners L1 and L3, conditioned under Conditions C, and the coated liners were dried on a hotplate at 120° C. for 15 minutes, the liner side of the assembly lying on the hotplate.

After the drying, the moisture content was determined separately for adhesive and for liner on one part of the specimen. Another part of the specimen was stored for 72 hours, sealed within vacuumed packaging impervious to permeation. Table 2 summarizes the results:

TABLE 2

| | | | | | Adhesive | |
|---|---|---|---|---|---|---|
| | | | | | water | Adhesive |
| | | | | Liner | content | water |
| | | | | water | [ppm | content |
| | | | | content | (mass | [ppm] |
| Exam- | | Adhe- | Liner | [ppm] | fraction)] | After |
| ple | Liner | sive | conditioning | After drying | | storage |
| 25 | L1 | K2 | Conditions C | 4300 | 2110 | 626 |
| C9 | L3 | K2 | Conditions C | 1900 | 1920 | 1810 |

Example 25 shows that even in the case of simultaneous drying of an adhesive on a polymer film-based liner with an equilibrium moisture content at 23° C. and 50% relative humidity (Conditions C) of more than 0.5 wt %, the drying of the adhesive is much further in the case of the joint storage. If this equilibrium moisture content is less than 0.5%, as in Comparative Example C9, there is no substantial further drying.

A further experiment looked at whether brief preliminary drying of the liners L3 and L4 for 5 minutes at 120° C. (Conditions D), as may be accomplished, for example, in a tunnel oven 50 m long at an operating speed of 10 m/min, results in a sufficient drying effect on the adhesive.

| | | | | | Adhesive | |
|---|---|---|---|---|---|---|
| | | | | | water | |
| | | | | Liner | content | Adhesive |
| | | | | water | [ppm | water |
| | | | | content | (mass | content |
| | | | | [ppm] | fraction)] | [ppm] |
| Exam- | | Adhe- | Liner | After conditioning/ | | After |
| ple | Liner | sive | conditioning | drying | | storage |
| C10 | L3 | K3 | Conditions D | 2150 | 1009 | 950 |
| 26 | L4 | K3 | Conditions D | 10 500 | 1009 | 730 |

Comparative Example 10 shows that liner 3, under drying conditions typical of a tunnel oven, cannot be given sufficient preliminary drying to bring about any significant drying of the adhesive. In particular, the water content is more than 75% of the water content of the liner at a temperature of 23° C. and a relative atmospheric humidity of 50%. Example 26 shows that this is possible with liner 4, a fact possibly attributable in particular to the very high water absorption capacity of the liner. This capacity is more than 0.5 wt %.

1. Method for removing water from an adhesive and/or for protecting an adhesive from ambient water, comprising
a) removing water from a release liner to a water content of at most 75 wt % of the release liner water content at a temperature of 23° C. and a relative atmospheric humidity of 50%, and
b) contacting the release liner with the adhesive.

2. Method according to claim 1, wherein the release liner comprises at least one polymeric film having a water absorption capacity of more than 0.5 wt %.

3. Method according to claim 2, wherein the polymeric film is a material selected from the group consisting of polyamide, polyamide copolymers, polyvinyl butyral, polyvinyl alcohol, polyvinyl acetate, cellulose acetate, cellulose acetate derivatives, cellulose hydrate, cellulose propionate, cellulose acetobutyrate, polysulphone and polysulphone derivatives.

4. Method according to claim 1, wherein the release liner comprises a layer having a water vapour permeation rate of at least 1000 g/m² for a thickness of 50 μm.

5. Method according to claim 1, wherein the release liner comprises at least one layer having a water absorption capacity of more than 0.5 wt % and at least one layer having a WVTR of ≦0.1 g/m²d, and the layer having a water absorption capacity of more than 0.5 wt %, after having been contacted with the adhesive, is disposed nearer to the adhesive than is the layer having the WVTR of ≦0.1 g/m²d.

6. Method according to claim 1, wherein step a) takes place before step b).

7. Method according to claim 1, wherein step b) takes place before step a).

8. Method according to claim 7, wherein energy required for removing the water is introduced substantially from the side of the release liner.

9. Adhesive tape covered on at least one side and at least partially with a release liner, and producible by a method according to claim 1.

10. Method for encapsulating an optoelectronic arrangement and/or an organic electronic arrangement, said method comprising encapsulating said arrangement(s) using an adhesive tape according to claim 9.

11. Release liner comprising at least one carrier material and at least one abhesive release layer, wherein the release liner is in the form of a roll and the side faces of two adjacent plies of the release liner are not in direct contact.

12. Release liner according to claim 11, wherein a membrane having a water vapour permeation rate of at least 1000 g/m²d for a thickness of 50 μm is wound in between the adjacent plies of the release liner.
